(19) United States
(12) Patent Application Publication
(10) Pub. No.: US 2015/0113460 A1
(43) Pub. Date: Apr. 23, 2015

(54) Data Analytics Animation System and Method

(71) Applicant: Wal-Mart Stores, Inc., Bentonville, AR (US)

(72) Inventors: Donald High, Noel, MO (US); Michael Atchley, Springdale, AR (US); Praveen Dodda, Bentonville, AR (US)

(21) Appl. No.: 14/061,437

(22) Filed: Oct. 23, 2013

(51) Int. Cl. G06F 3/0484

(52) U.S. Cl. CPC G06F 3/0484
USPC 715/771

(57) ABSTRACT

A method for animating data analytics on a display is provided. The method includes receiving, at a processor, a first request to display a set of data, the set of data including a plurality of data dimensions having respective data. The method includes generating one or more visualizations of the set of data corresponding to at least two data dimensions. The method includes applying a filter to select one or more data ranges to be displayed along the at least two data dimensions. The method includes displaying each of the one or more visualizations at respective sets of pixels of the display based upon the applied filter. The method includes generating respective animations of the displayed one or more visualizations by simultaneously displaying respective variations in the at least two data dimensions on the respective sets of the pixels of the display.

### FIELD OF THE DISCLOSURE

An aspect of the present disclosure is generally related to data analytics displays, and more particularly to a data analytics animation system and method.

### BACKGROUND OF THE DISCLOSURE

Conventional visualizations of data analytics, for example, charts and graphs, are fixed or static visualizations with respect to time or other data dimension. Certain linked visualizations navigate through data dimensions and update other visualizations on more than one display areas or panels. However, even with the updating, these linked visualizations do not offer much flexibility in visualizing the data in real time as the data is being updated or other parameters of the data are being selected different from the ones being displayed through the visualizations. For example, such visualizations, such as those implemented using Google Analytics, are restricted to specific languages and environments for statistical computing and graphics, such as “R”, which are computationally burdensome or slow. Such conventional systems are thus not very efficient when presenting animated visualizations to a time-pressed audience, e.g., C-level executives (Chief Executive Officers or CEOs, etc.).

### SUMMARY OF THE DISCLOSURE

In view of the foregoing, there is a need for a data analytics animation system and method that presents visualizations in real time, in a fast manner, as the data associated with the visualizations is updated at the back-end or as a different set of data is selected for display, without manual intervention to the visualizations themselves.

Some aspects of the present disclosure address at least the issues discussed above.

In accordance with one aspect of the present disclosure a method for animating data analytics on a display is provided. The method includes receiving, at a processor, a first request to display a set of data, the set of data including a plurality of data dimensions having respective data. The method includes generating one or more visualizations of the set of data corresponding to at least two data dimensions. The method includes applying a filter to select one or more data ranges to be displayed along the at least two data dimensions. The method includes displaying each of the one or more visualizations at respective sets of pixels of the display based upon the applied filter. The method includes generating respective animations of the displayed one or more visualizations by simultaneously displaying respective variations in the at least two data dimensions on the respective sets of the pixels of the display. The method includes altering, as the filter is applied, at least one data dimension such that the one or more visualizations are concurrently updated during the respective animations to reflect the altered at least one data dimension.

In accordance with one aspect of this disclosure, a computer readable medium storing computer executable instructions thereupon for animating data analytics on a display is provided. The instructions when executed by a processor cause the processor to receive a first request, at the input-output interface, to display the set of data, the set of data including a plurality of data dimensions having respective data, generate at least two visualizations of the set of data corresponding to at least two data dimensions, apply a filter to select one or more data ranges to be displayed along the at least two data dimensions, display, at the display, each of the at least two visualizations at respective at least two sets of pixels of the display, generate respective animations of the displayed at least two visualizations by simultaneously displaying respective variations in the at least two data dimensions on the respective at least two sets of the pixels of the display to a viewer viewing the display, and alter, as the filter is applied, at least one data dimension such that the at least two visualizations are updated during the respective animations to reflect the altered at least one data dimension.

In accordance with one aspect of this disclosure, a data analytics animation system is provided. The data analytics animation system includes a computing device. The computing device includes a database including a memory having instructions stored thereupon to animate data analytics associated with a set of data stored in the database, a processor coupled to the database, an input-output interface coupled to the processor, and a display unit coupled to the processor. The instructions when executed by the processor, cause the processor to receive a first request, at the input-output interface, to display the set of data, the set of data including a plurality of data dimensions having respective data, generate at least two visualizations of the set of data corresponding to at least two data dimensions, apply a filter to select one or more data ranges to be displayed along the at least two data dimensions, display, at the display, each of the at least two visualizations at respective at least two sets of pixels of the display, generate respective animations of the displayed at least two visualizations by simultaneously displaying respective variations in the at least two data dimensions on the respective at least two sets of the pixels of the display to a viewer viewing the display, and alter, as the filter is applied, at least one data dimension such that the at least two visualizations are updated during the respective animations to reflect the altered at least one data dimension.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 is a schematic diagram of an exemplary data analytics animation system, in accordance with an aspect of the present disclosure.

FIG. 2 is a schematic diagram of an exemplary computer system of the data analytics animation system of FIG. 1 configured to provide data analytics animation, in accordance with an aspect of the present disclosure.

FIG. 3 is a flow diagram of an exemplary method for animating data analytics on a display of the data analytics animation system of FIG. 1 using, for example, the computer system of FIG. 2, in accordance with an aspect of the present disclosure.

FIGS. 4-9 illustrate exemplary visualizations for generating animation using the data analytics animation system of FIG. 1, for example, according to the method of FIG. 3, in accordance with an aspect of the present disclosure.

FIG. 10 illustrates an exemplary graph with user interface control buttons or icons, in accordance with an aspect of the present disclosure.

### DETAILED DESCRIPTION

The aspects of this disclosure are not limited in its application to the details of construction and the arrangement of components set forth in the following description or illustrated in the drawings. The aspects of this disclosure may be configured to be carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

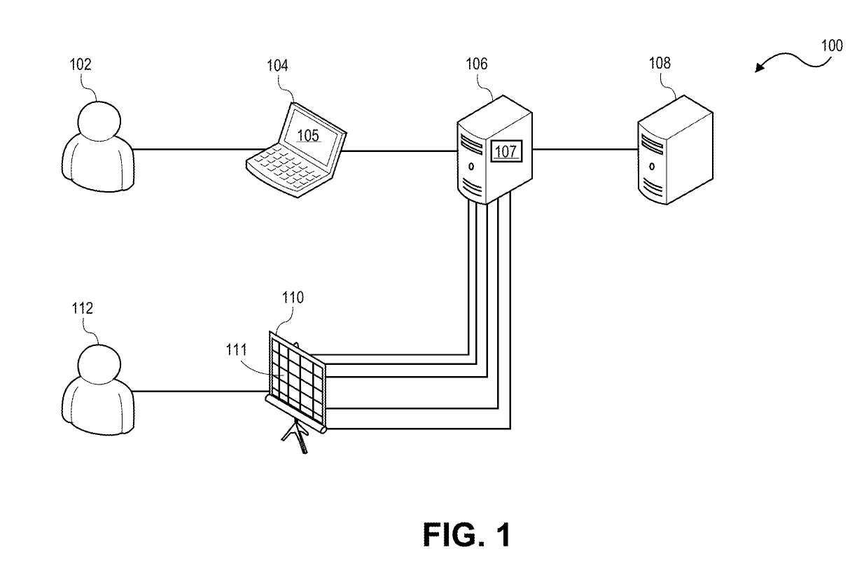

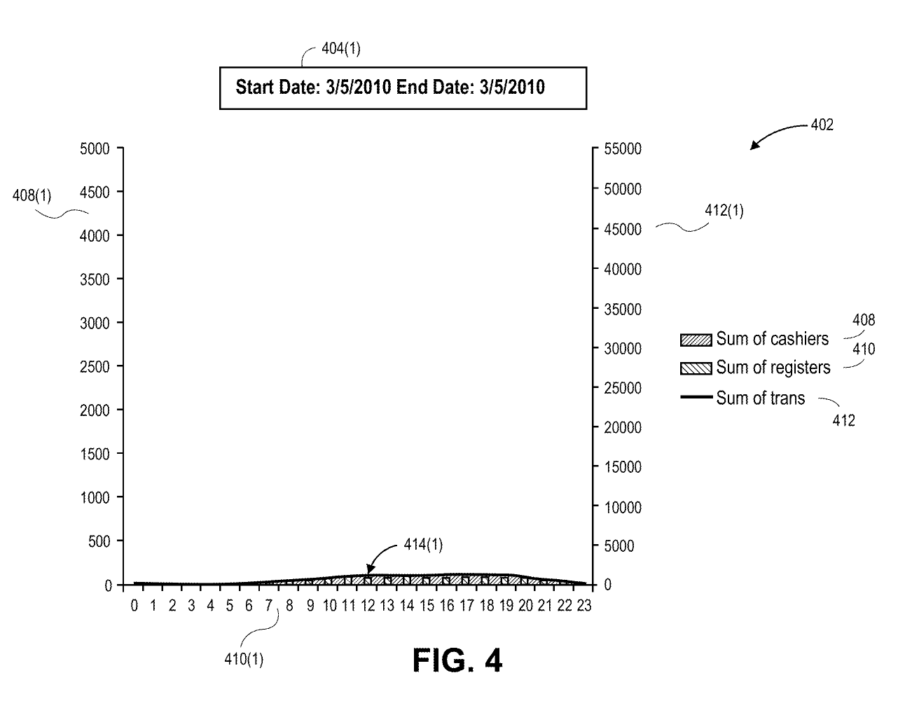

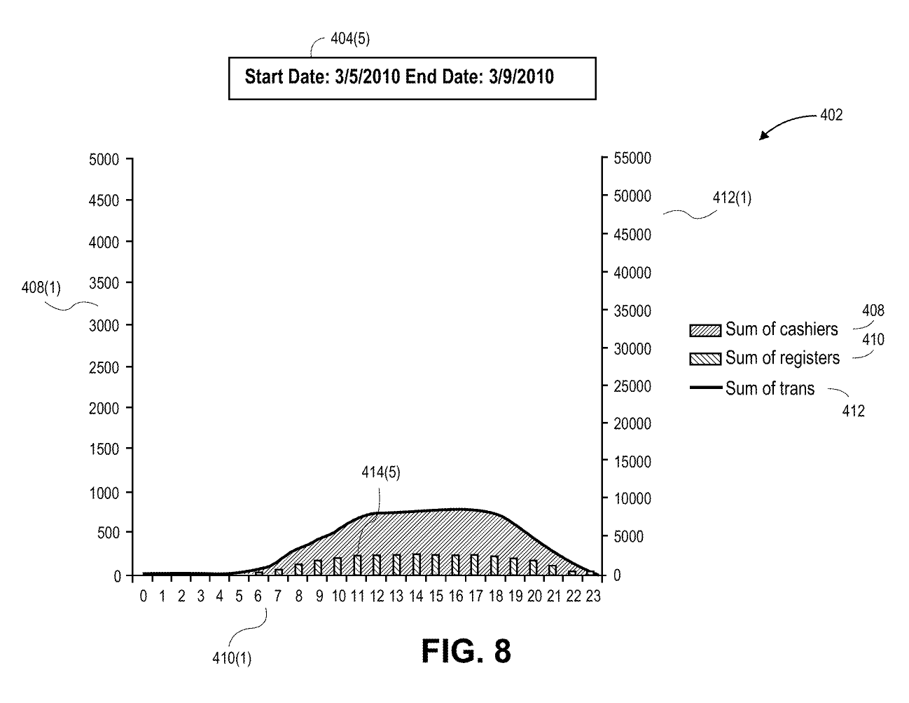

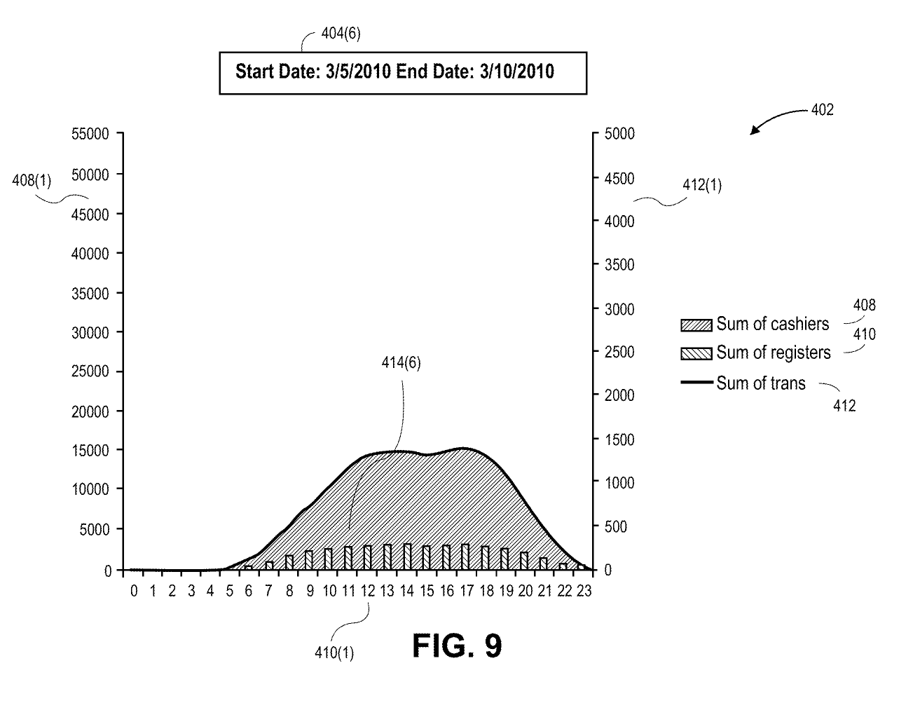

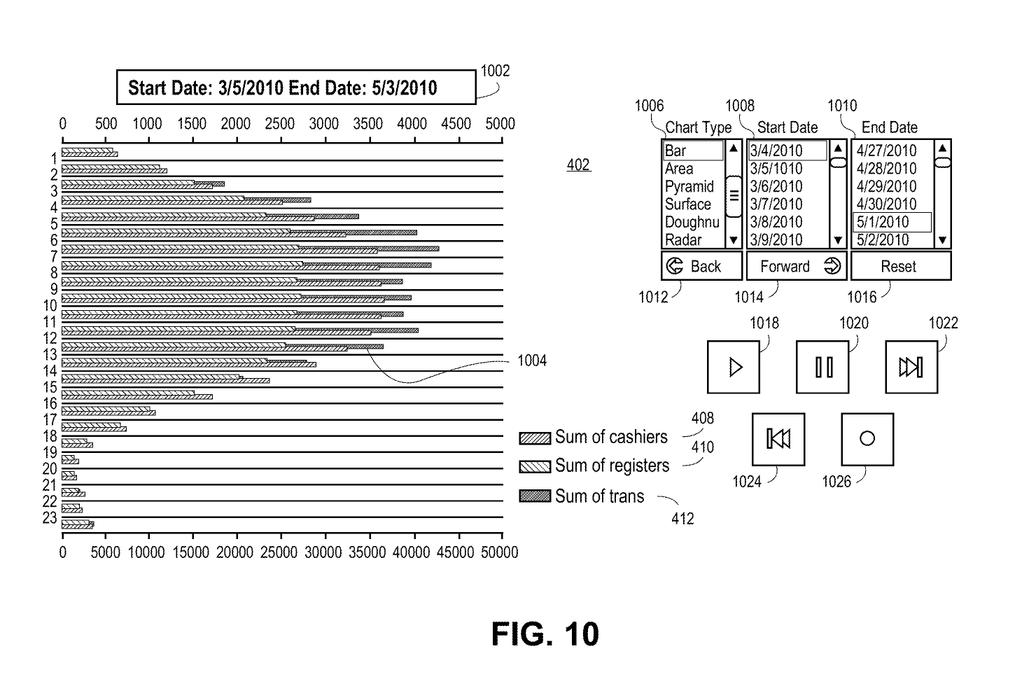

An aspect of the present disclosure is directed to a data analytics animation system 100 illustrated in FIG. 1. The data analytics animation system 100 is generally configured to show visualizations of different analytical model results displayed in motion using Video Cassette Recorder or “VCR” type controls to switch to different presentation formats such as fast-forward, fast-reverse, etc., as well as to change scales of data, e.g., from daily, to weekly, to monthly, to quarterly, and to yearly, etc. Such VCR type controls may be implemented using VCR control buttons or icons 1012, 1014, 1016, 1018, 1020, 1022, 1024, and 1026 are illustrated in FIG. 10, by way of example only, although other types of graphical or non-graphical user interfaces may be used. Analytical models that are displayed through the visualizations by the data analytics animation system 100 may be geospatial, line, bar graph, area graphs, pie-charts, donut charts, radar type charts, and/or other types of display visualizations known to one of ordinary skill in the art. Such chart types 1006 are illustrated as a list to select from in FIG. 10. Likewise, a time range 1002 may be selected using a start date range 1008 and an end date range 1010. It is to be noted that the term “date” as used herein may relate to any time or variation in a data parameter, and is not restricted to calendar dates only. For example, other start variables and end variable may be used such as income ranges, age, etc. By way of example only, a graph or a chart would start at an earliest logical point in a data set and then progress slowly incrementally or otherwise by day, week, month, quarter, or year depending upon VCR type controls implemented by the buttons 1012, 1014, 1016, 1018, 1020, 1022, 1024, and 1026. For example, a reverse function using the VCR type control button 1012 would slow down the presentation or visualization until it reaches the daily level and then would reverse the day, week, month, quarter, and year. A pause functionality may be implemented by the button 1020 that would halt the display at the current position. Similarly, the play button 1018 would resume a presentation or visualization 402. Likewise, a stop button 1026 would be used to reset the graph or chart. Additional buttons such as a forward-skip button 1022 and a reverse-skip button 1024 may be used. Further, such buttons 1012, 1014, 1016, 1018, 1020, 1022, 1024, and 1026 may be provided to provide time-warped display of the visualization 402 as an evolving graph 1004, which includes randomly chronological display not in any particular order. Such “buttons” 1012, 1014, 1016, 1018, 1020, 1022, 1024, and 1026 may be provided on an input device (e.g., on a remote control unit). In one aspect, the evolving graph 1004 may be reset to zero or an initial starting point using the reset button 1016. The forward button 1014 may be used to move the time range or dates for which the evolving graph 1004 is plotted. The evolution of the graph 1004 is presented in FIGS. 4-9, using different reference numeral. Alternatively, such “buttons” 1012, 1014, 1016, 1018, 1020, 1022, 1024, and 1026 may be provided as graphical user icons or interfaces (“GUIs”) on a display of the data analytics animation system 100, as discussed below. Geospatial graphs would also be able to show in motion as they are zoomed in or zoomed out of a particular geographical area, e.g., on a map. Other graphs may be used to zoom in or out based upon who (e.g., customer types, member profiles, leaders, store types, etc.) and what (e.g., products, items, fine-line, department, and suppliers).

The VCR buttons 1012, 1014, 1016, 1018, 1020, 1022, 1024, and 1026 may control a direction and a speed of the animation resulting from the evolving graph 1004. The animation may occur either from prebuilt charts/graphs, prerecorded analytical model results, or from dynamic chart/graph construction as the data analytics animation system 100 is in use. For example, when prebuilt charts are used, they may be sequentially assembled into a message or a story that could be played in either direction by switching from one chart to the next, as indicated by the chart types 1006. Prebuilt charts may provide an efficient approach but may be not very flexible and may require reconstruction daily when in picture format. Pre-recorded charts may also have to be constructed in advance but may automatically be sequenced as they would be recorded in their respective order. Pre-recorded charts may not be assembled pictures but rather charts pre-constructed allowing for some flexibility in changes. Dynamically building the charts on the fly may require either an algorithm or data script for the process to follow to build the flow of charts to display, telling the analytical story or message to an audience. Various aspects of the disclosure may be used to provide an illusion of animation for these visual data analytics by showing variations or evolutions of the graph 1004.

The presentation of data analytics, e.g., to senior leadership level personnel or other time constrained individuals in an organization or a meeting is challenging with respect to conveying maximum information in the least time in an exciting, and at the same time, meaningful way. Various visualizations provided by the data analytics animation system 100 provide attention capturing and exciting approach of showing analytics as evolution of data progresses through time or other data dimensions. Various aspects of the present disclosure provide an efficient visualization and animation approach to communicate data analytics for quickly identifying areas of opportunities for various individuals or organizations viewing the data analytics in minimum amount of time.

Referring to FIG. 1, in one aspect of the disclosure, the data analytics animation system 100 may include an agent 102 communicating with a data analytics setup computer 104. The data analytics setup computer 104 is coupled to an analytics engine computer 106. The analytics engine computer 106 is coupled to a database server device 108 and to a display 110. The display 110 may be viewed by one or more viewers 112. The communication between the agent 102 and the respective couplings between the data analytics setup computer 104, the analytics engine computer 106, the database server device 108, and the display 110 may be over wired, optical, or wireless channels, or combinations thereof. Further, such couplings may be in other topologies than that shown in FIG. 1. For example, some components of the data analytics animation system 100 may be in one physical space (e.g., same building), while some other may be in a different physical space (e.g., another city), and may be communicably coupled to each other over a communication network (not shown). Such a communication network may be the Internet, a private network, a Virtual Private Network (VPN), a Local Area Network (LAN), a Wide Area Network (WAN), and/or combinations thereof, as may be understood by one of ordinary skill in the art. Furthermore, in one aspect of the disclosure, one or more components of the data analytics animation system 100 may be combined into one. For example, the data analytics setup computer 104, the analytics engine computer 106, the database server device 108, and the display 110 may all be part of a single computer device. In another example, the data analytics setup computer 104 and the analytics engine computer 106 may be a front-end of a computer device and the database server device 108 may be a back-end for such a computer. The terms “front-end” and “back-end” have conventional meanings known to one of ordinary skill in the art. In yet another example, the agent 102 may be remote or physically away from the system and the one or more viewers 112 may be guided by the agent 102 to communicate with the data analytics setup computer 104 to view one or more visualizations of data analytics, in accordance with various aspects of this disclosure. Similarly, one or more components of the data analytics animation system 100 may be optional and various functionalities and features of such components, when optional, may be carried out by other devices in the data analytics animation system 100.

The agent 102 may be an entity that is capable of or is configured to setup various parameters for proper function of the data analytics animation system 100. In one aspect of the disclosure, the agent 102 may be a physical entity. Alternatively, in one aspect of the disclosure, the agent 102 may be a software agent that can be programmed to assist or even replace a physical entity for the agent 102. By way of example only, the agent 102 may be a human being (e.g., a data specialist), a robot, or an electronic device that may communicate with the data analytics setup computer 104 by exchanging signals over wired, optical, or wireless channels to setup the data analytics animation system 100 for appropriate operation. Further by way of example only, the agent 102 may be, in addition to or alternatively with the physical entity, a software agent executing on a computer (e.g., the data analytics setup computer 104). Such a software agent may include code or a set of instructions residing on a memory of the data analytics setup computer 104, which code when executed by a processor of the data analytics setup computer 104, causes the processor to implement the various features and functionalities of the data analytics animation system 100, as discussed herein (e.g., presenting various visualizations on the display 110). In one aspect of the disclosure, the agent 102 may send one or more requests to the data analytics setup computer 104 for manipulating data and initiating the animations of one or more data visualizations provided by the data analytics animation system 100 on the display 110, as discussed herein.

The data analytics setup computer 104 may include a processor, a memory, a communications interface configured to receive a request to setup the data analytics animation system 100. By way of example only, the data analytics setup computer 104 maybe a laptop, a personal computer, a desktop, a hand-held computing device, or other types of computing devices having code residing on the memory, which code when executed by the processor of the data analytics setup computer 104, cause the processor to process one or more requests received from the agent 102 to setup the data analytics animation system 100 for use. Examples of the request may include data packets with information from sales from a previous year with a comparison of the sales from the current year on a week by week basis accumulating up to the total sales for the year. Another type of request may be to present a store count and head count for a merchant's stores on a map day by day through the year indicating density by color going from light blue to dark red based upon increments.

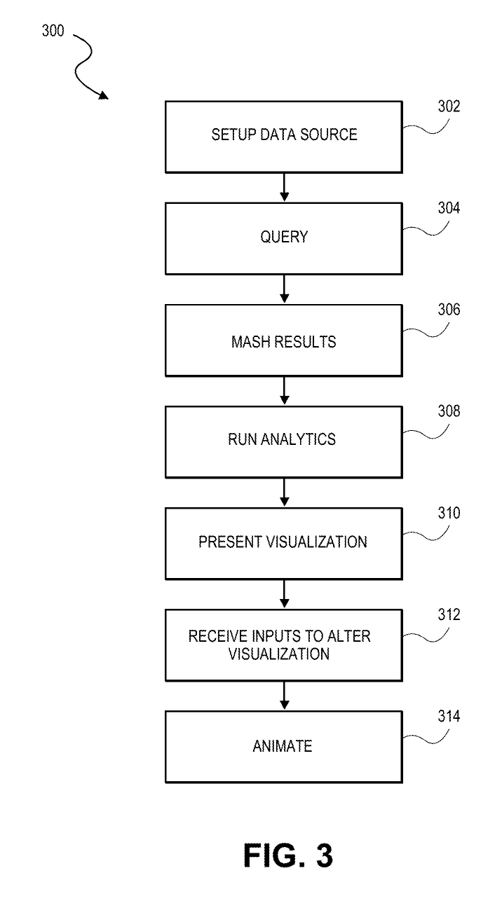

The analytics engine computer 106 may include a processor, a memory, a communications interface, and an analytics engine 107 stored on the memory. By way of example only, the analytics engine computer 106 maybe a laptop, a personal computer, a desktop, a hand-held computing device, or other types of computing devices having code residing on the memory, which code when executed by the processor of the analytics engine computer 106, cause the processor to implement the analysis engine 107. For example, the analytics engine computer 106 may be configured to query the database server device 108 to obtain various items of data that may be used to generate the animations of the visualizations presented on the display 110. In one aspect of the disclosure, the analytics engine 107 may be configured to carry out various iterations discussed in FIG. 3, e.g., to rebuild one or more visualizations on the display 110 to generate the animations.

The database server device 108 may be a server device having processors, memory or other non-transitory storage media, input-output interfaces, buses, power supply and cooling systems, as known. The database server device 108 may be configured to store a plurality of data in various forms, e.g., data structures known to those of ordinary skill in the art. Data may be stored in various dimensions, e.g., one dimension, two dimensions, three dimensions, or higher dimensional hyper-cubes of data. Such data may be subject to extraction or slicing along one or more data dimensions for performing the one or more visualizations on the display 110. The database server device 108 may store data as done in databases such as those provided by Teradata Corporation of Dayton, Ohio, DB2®, or INFORMIX® from IBM Corporation of Armonk, N.Y., SQL SERVER® from Microsoft Corporation of Redmond, Wash., databases from Oracle Corporation of Redwood Shores, Calif., combinations thereof, or other databases known to one of ordinary skill in the art. The types of databases may be, for example, market basket, general merchandise, forecasting, and others. The database server device 108 may then provide such data to the analytics engine 107 for combining or mashing the results obtained from querying such data, as discussed in FIG. 3.

The display 110 includes a plurality of pixels or pixel groups 111. Such pixels or pixel groups 111 have physical properties such as illuminiscence, reflectance, fluorescence, etc., which are transformed based upon the visualizations controlled by the processor 210 or other graphics processor(s). The display 110 may be a screen, a monitor, or other types of surfaces on which one or more data visualizations may be projected. For example, the screen may be a projector screen or a wall, the monitor may be a computer monitor, a liquid crystal display monitor, a high-definition monitor, and the like, or combinations thereof. In one aspect of the disclosure, the display 110 may be coupled to a graphics or display processor (not shown) in communication with the analytics engine computer 106 for controlling the one or more data visualizations achieved by the data analytics animation system 100. In one aspect of the disclosure, the display 110 includes a plurality of pixels. Each of the plurality of pixels may be controlled by the display processor to vary intensity levels indicative of the one or more data visualizations. For example, the pixels 111 may be addressable by the graphics or display processor. Further, the groups of pixels in the plurality of pixels 111 may be allocated to one or more forms of data visualizations. For example, one group of pixels may be configured to display a static or an animated bar chart while another group of pixels may be configured to show a static or an animated line graph, and so on, as may be understood by one of ordinary skill in the art. As discussed with respect to FIG. 3, based upon variations in the data stored in the database server device 108, one or more physical properties of sets of pixels may be transformed to create the one or more data visualizations (e.g., animations) on the display 110. The display controller of the display 110 may configure the display 110 to be refreshed at an appropriate raster scan rate to accommodate the transformation of the physical properties of the pixels to show the animations in a visually pleasing manner, as discussed in FIG. 3.

The one or more data visualizations on the display 110 are provided to the one or more viewers 112. Such one or more viewers 112 may be individuals or groups of individuals who can make informed decisions regarding various matters based on the presentation of the one or more visualizations on the display 110. By way of example only, the one or more viewers may include “C-level” executives, senior policy makers, members of the public, or other users of the data analytics animation system 100 for whom a presentation may be geared towards. In one aspect of the disclosure, the one or more viewers 112 may be independent of the data analytics animation system 100, and/or may be end users thereof.

Various aspects and functions described herein in accordance with the present embodiments may be implemented as hardware, as software, or a proper combination of both, on one or more computer systems or electronic devices. There are many examples of computer systems currently in use. These examples include, among others, network appliances, personal computers, workstations, mainframes, networked clients, servers, media servers, application servers, database servers, and web servers. Other examples of computer systems may include mobile computing devices, such as cellular phones and personal digital assistants, and network equipment, such as load balancers, routers and switches. Further, one or more aspects of the disclosure may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the aspects of the disclosure are not limited to being executed on any particular system or group of systems. Further, aspects may be implemented in software, hardware or firmware, or any proper combination(s) thereof. Thus, the aspects may be implemented within methods, acts, systems, system elements and components using a variety of hardware and software configurations, and the embodiments are not limited to any particular distributed architecture, network, or communication protocol.

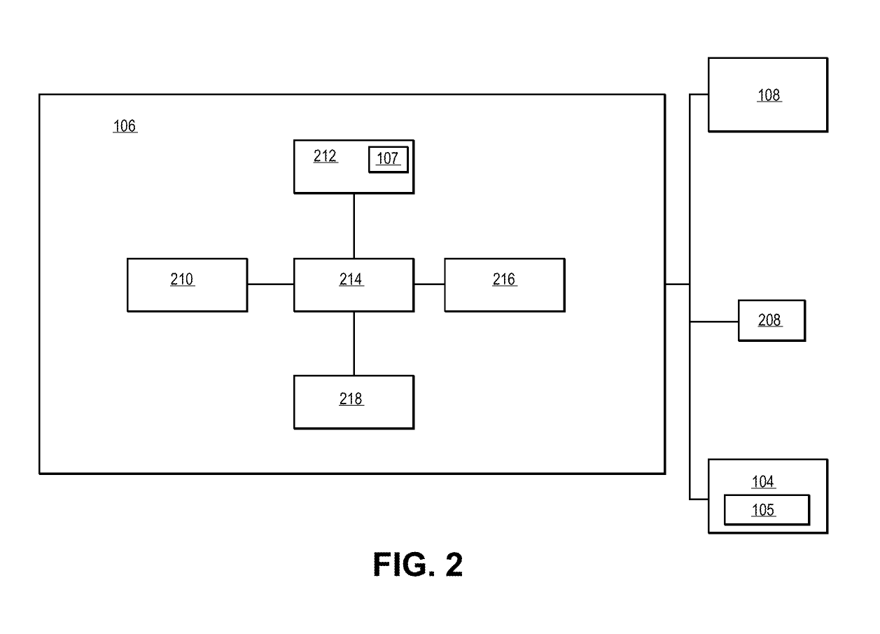

FIG. 2 shows a block diagram of the analytics engine computer 106 as computer device, in which various aspects and functions in accord with the present embodiments may be practiced. The analytics engine computer 106 may include or may be coupled to one more computer systems. For example, as illustrated, the analytics engine computer 106 is coupled to the data analytics setup computer 104 and the database server device 108. As shown, the data analytics setup computer 104, the analytics engine computer 106, and the database server device 108 are interconnected by, and may exchange data through a communication network 208. The network 208 may include any communication network through which computer systems may exchange data. To exchange data using the network 208, the data analytics setup computer 104, the analytics engine computer 106, and the database server device 108, and the network 208 may use various methods, protocols and standards, including, among others, token ring, Ethernet, wireless Ethernet, Bluetooth, TCP/IP, UDP, Http, FTP, SNMP, SMS, MMS, SS7, Soap, and Corba. To ensure data transfer is secure, the data analytics setup computer 104, the analytics engine computer 106, and the database server device 108 may transmit data via the network 208 using a variety of security measures including TLS, SSL or VPN among other security techniques. While FIG. 2 illustrates three networked computer systems, the data analytics setup computer 104, the analytics engine computer 106, and the database server device 108, various aspects of the disclosure may include any number of computer systems and computing devices, networked using any medium and communication protocol.

Various aspects and functions in accordance with the present embodiments may be implemented as specialized hardware or software executing in one or more computer systems including the analytics engine computer 106 shown in FIGS. 1 and 2. As depicted, the analytics engine computer 106 includes a processor 210, a memory 212, a bus 214, an interface 216, and a storage 218. The processor 210 may perform a series of instructions that result in manipulated data. The processor 210 may be a commercially available processor such as an Intel Pentium, Motorola PowerPC®, Sun UltraSPARC™, or Hewlett-Packard PA-RISC™ processor, but may be any type of processor, multi-processor, microprocessor or controller as many other processors and controllers are available. The processor 210 is connected to other system elements, including one or more memory devices 212 by a bus 214.

The memory 212 may be used for storing programs and data during operation of the analytics engine computer 106. Thus, the memory 212 may be a relatively high performance, volatile, random access memory such as a dynamic random access memory (DRAM) or static random access memory (SRAM). However, the memory 212 may include any device for storing data, such as a disk drive or other non-volatile, non-transitory, storage device. Various embodiments in accordance with the present invention may organize the memory 212 into particularized and, in some cases, unique structures to perform the aspects and functions disclosed herein. In one aspect of the disclosure, the memory 212 may be used to store the analytics engine 107. For example the memory 212 may store one or more instructions in suitable code or programming language to implement the analytics engine 107. These instructions may be executed by the processor 210 and cause the processor 210 to implement the various features and functionalities of the data analytics animation system 100 discussed herein.

The components of the analytics engine computer 106 may be coupled by an interconnection element such as the bus 214. The bus 214 may include one or more physical busses, for example, busses between components that are integrated within a same machine, but may include any communication coupling between system elements including specialized or standard computing bus technologies such as IDE, SCSI, PCI, and InfiniBand. Thus, the bus 214 enables communications, for example, data and instructions, to be exchanged between system components of the analytics engine computer 106.

The analytics engine computer 106 includes one or more interface devices 216 such as input devices, output devices, and combination input/output devices. The interface devices 216 may receive input or provide output. More particularly, output devices may render information for external presentation. Input devices may accept information from external sources. Examples of interface devices 216 include keyboards, mouse devices, trackballs, microphones, touch screens, printing devices, display screens, speakers, network interface cards, etc. The interface devices 216 allow the analytics engine computer 106 to exchange information and communicate with external entities, such as users and other systems.

The storage system 218 may include a computer readable and writeable, nonvolatile, non-transitory, storage medium in which instructions are stored that define a program to be executed by the processor. The storage system 218 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk, or flash memory, among others. In operation, the processor or some other controller may cause data to be read from the nonvolatile recording medium into another memory, such as the memory 212, that allows for faster access to the information by the processor than does the storage medium included in the storage system 218. The memory may be located in storage system 218 or in the memory 212, however, the processor 210 may manipulate the data within the memory 212, and then may copy the data to the medium associated with the storage system 218 after processing is completed. A variety of components may manage data movement between the medium and integrated circuit memory element and the presently described embodiments are not limited thereto.

The analytics engine computer 106 may be a computer system including an operating system that manages at least a portion of the hardware elements included in the analytics engine computer 106. Generally, a processor or controller, such as the processor 210, executes an operating system which may be, for example, a Windows-based operating system such as Windows NT®, Windows 2000® (Windows ME®), Windows XP®, or Windows Vista® operating systems, available from the Microsoft Corporation of Redmond, Wash., a MAC OS® System X operating system available from Apple Computer of Cupertino, Calif., one of many Linux-based operating system distributions, for example, the Enterprise Linux operating system available from Red Hat Inc. of Raleigh, N.C., a Solaris operating system available from Oracle Corporation of Redwood Shores, Calif., or a UNIX operating system available from various sources. Many other operating systems may be used, and the aspects are not limited to any particular implementation.

The processor 210 and the operating system together define a computer platform for which application programs in high-level programming languages may be written. These component applications may be executable, for example, C−, byte code or interpreted code that communicates over a communication network, for example, the Internet, using a communication protocol, for example, TCP/IP. Similarly, various aspects of the disclosure may be implemented using an object-oriented programming language, such as .Net, to SmallTalk, Java, C++, Ada, or C# (C-Sharp) to implement functionality of the analytics engine 107. Other object-oriented programming languages may also be used. Alternatively, functional, scripting, or logical programming languages may be used.

Additionally, various aspects and functions in the present disclosure may be implemented in a non-programmed environment, for example, documents created in HTML, XML, or other format that, when viewed in a window of a browser program, e.g., of the display 110, render aspects of a graphical-user interface or perform other functions. Further, various embodiments in accord with the present invention may be implemented as programmed or non-programmed elements, or any combination thereof. For example, a web page may be implemented using HTML while a data object called from within the web page may be written in C++. Thus, the presently disclosed aspects are not limited to a specific programming language and any suitable programming language could also be used.

Although the above description discuses hardware implementation details of the analytics engine computer 106, similar hardware may be used for the data analytics setup computer 104 and the database server device 108. In one instance, for example for the database server device 108, aspects of the data analytics animation system 100 may be implemented using an existing commercial product, such as, for example, Database Management Systems such as SQL SERVER® available from Microsoft Corporation of Redmond, Wash., Oracle Database from Oracle Corporation of Redwood Shores, Calif., and MySQL from MySQL AB, a subsidiary of Oracle or integration software such as Web Sphere middleware from IBM Corporation of Armonk, N.Y. However, a computer system running, for example, SQL Server may be able to support both aspects.

Referring to FIG. 3, an exemplary method 300 for data analytics animation may begin at an operation 302. In the operation 302, the agent 102 may send a request to the processor 210 to setup the data analytics animation system 100 to display one or more visualizations of the data stored in the database server device 108. Such a request may be received at the processor 210 via the data analytics setup computer 104. As discussed, the agent 102 may be a user of the data analytics animation system 100 (e.g., a sales representative) who presents one or more visualizations on the display 110 for the one or more viewers 112 (e.g., corporate executives). In one aspect, such a request received at the processor 210 may include one or more types of visualizations that are to be displayed on the display 110. For example, the agent 102 may request selection of one or more sets of data (e.g., arrays or rows of data) and request displaying such data against another set of data. Further by way of example only, the request may include setting up different forms of visualization. Such requested setup may be implemented by the agent 102 selecting types of graphs, charts, lines, etc., on a graphical user interface (“GUI”) presented on a display 105 of the data analytics setup computer 104, although other types of selection modes (e.g., command line interfaces) may be used. In one aspect of the disclosure, in the operation 302, the agent 102 may setup or configure the database server device 108, which acts as a data source. Such configuration may be part of the request to setup the analytics data animation system 100. Alternatively, such configuration may be carried out independent of the request. In one aspect, such configuration is carried out in real time or dynamically, as the data is being displayed on the display 110 to the one or more viewers. The terms “dynamically” or “real time” in this context relate to data operations, setup operations, and/or visualization setup operations being carried out as the visualizations or animations therein are being presented on the display 110. In another example, the terms “dynamically” or “real time” refer to data manipulation of one or more sets of data on the database server device 108 being carried out while the data analytics animation system 100 is being actively used by the agent 102 and/or the one or more viewers 112, as juxtaposed with manipulating the data when the data analytics animation system 100 is not being used (e.g., when there are no visualizations being presented on the display 110). For example, real time or dynamic updating may relate to an operation in which as time passes, an animation of the visualization on the pixels 111 would change. Correspondingly, the new information extending the range of the graph may be shown, and old data out of range may be removed. A historical range of data may be continued to show so that what happened recently can be compared against what had happened in the past.

In an operation 304, the processor 210 may receive a query from the agent 102 to query the one or more data sets stored in the database server device 108. In one aspect, the agent 102 may send the query using the GUI presented on the display 105 of the data analytics setup computer 104 or directly at the analytics engine computer 106. Such querying may include setting up a filter configured to select one or more conditions to be applied to the one or more sets of data stored on the database server device 108. Tables I-VI below illustrate examples of such a filter, as applied for generating data analytics animation using the data analytics animation system 100 and the method 300, discussed with respect to FIGS. 4-9. For example, such a filter may be used by the agent 102 to select which rows of data are to be displayed against which rows on the display 110. Other parameters selectable using such a filter may be a number of rows of data selected during animation, scale, etc., as discussed, e.g., with respect to FIGS. 4-9. In one aspect, such a filter may be used to force one or more visualizations to reflect changes incrementally one row of data at a time generating an illusion of an animation of the visualization on the display 110 to the one or more viewers 112. Such animations may then quickly and in real time present evolution of various parameters associated with the data stored in the database server device for the one or more viewers 112 to interpret and make appropriate decisions. For example, one or more patterns regarding such data may be revealed as a result of the generated animation(s). Further details of generation of such animation are discussed with respect to FIGS. 4-9 using an exemplary scenario or use case.

In one aspect of the disclosure, the term “filter” relates to a limit of what is to be shown as part of the visualization of the pixels 111. For example, if there are 1000 rows of data, the filter will only show 1 initially. Then, the visualizations are updated to show 2, 3, 4, 5, etc., rows until a row counter reaches the full 1000^{th} row. This mode of operation of the filter is termed as an “accumulation mode.” Likewise, in a switching mode, only the first 10 rows may be shown initially, and the counter may then move up 1 row at a time to show rows 2 through 11, 3 through 12, and so on as the 10 row window moves through the total 1000 rows of information, to implement the filter. Such changes or updates to the filter correspondingly appear as one or more animations on the pixels 111.

In an operation 306, the processor 210 “mashes” or combines the results obtained from the database server device 108 as a result of the querying in the operation 304. Such combining may include bringing the data from various sources in various formats to a common format for processing by the processor 210. For example, the data in the database server device 108 may be arranged in multiple rows and stored in a memory device thereof (similar to the memory device 212). Each such row may then include a plurality of metrics (e.g., sales data based on amount, geography, time stamps, type of items sold, customer type, etc.). The processor 210 may obtain such diverse data based on the query (implemented by the filter) and process the diverse data to a common format. Mashing of information occurs when results from one query are taken and combined with results from another query. For example, one query may return a list of stores for USA and another query may return the sales for all USA stores, but mashing puts the two sets of data together.

In an operation 308, the processor 210 executes the analytics engine 107 on the mashed data. Such analytics may be used to select which parameters or metrics of the data are to be displayed in one or more visualizations presented on the display 110. Upon execution by the processor 210 in the operation 308, the analytics engine may select apply different visual cues for presenting the selected data based upon one or more inputs from the agent 102, as indicated by the application of the filter exemplarily illustrated using Tables I-VI below. In one aspect, such analytics may be performed prior to the presentation of the one or more visualizations or generation of animation in the visualizations on the display 110. In one aspect, the analytics may be performed during the presentation of the one or more visualizations or generation of animation in the visualizations on the display 110 in real-time or dynamically, as various selections of data or data sets are being received by the processor 210 from the agent 102 and/or the one or more viewers 112 and provided to one or more of the plurality of pixels 111 of the display 110.

In an operation 310, based upon the various selections and the application of the filter by the agent 102, the processor 210 presents one or more visualizations on the display 110. Such visualizations are shown by way of example only in FIGS. 4-9. Such visualizations may be two or more linked graphs displayed on two different sets of pixels or pixel groups of the display 110. One or more tangible properties (e.g., fluorescence, brightness, etc.) of the pixels or pixels groups may be transformed based upon the presentation of such one or more visualizations. For example, a pixel group may have an initial color, brightness or intensity, contrast, or other visually perceptible property when a first visualization is initially presented. Such a pixel group may be one of the plurality of pixel groups 111 of the display 110. Upon a change to the first visualization, the pixel group may have a different property (e.g., higher or lower fluorescence). In one aspect, a second visualization may be presented concurrently with the first visualization but at another pixel group different from the pixel group on which the first visualization was presented. The two visualizations, and hence the properties of the corresponding pixels, may be linked in terms of the data metrics being presented to the viewers 112 on the display 110. For example, the first visualization may present variables V₁ and V₂ as a graph. Simultaneously, the second visualization may present variables V₂ and V₃ as a pie-chart. Similarly, additional number of variables or metrics (e.g., three or more variables) and additional number of visualizations (e.g., three or more) may be presented as linked visualizations on the display 110. The term “linked” as referred to herein relates to variables V₁, . . . , Vₙ of the same data set stored in the database server device 108, the index ‘n’ being an integer value. In an alternative aspect, two or more visualizations on the display 110 may present different variables from different data sets stored on the database server device 108, as may be contemplated by one of ordinary skill in the art in view of this disclosure.

In an operation 312, the processor 210 receives one or more inputs from the agent 102 and/or one more viewers 112 to determine a type of visualization that is to be presented on the display 110. In one aspect, the one or more inputs may be used to alter, as the filter(s) are applied, at least one data dimension or other parameters of the visualization such that the visualizations are concurrently updated for different parts of the pixels 111. For example, as animations are being carried out, such updates to alter the visualizations may be reflected in real-time as the one or more viewers 112 are viewing the changes to the visualizations. Such changes may be perceived as animations by the one or more viewers 112 since these changes occur at a fast visual rate. Specific values of such visual rates may vary, as may be understood by one of ordinary skill in the art. For example, using the GUI on the display of the data analytics setup computer 104, the agent 102 may select a range of data, a type of graph, a scale, a color scheme, or other visual cues that are useful for indicating different characteristics of the one or more visualizations presented on the display 110. In one aspect, the agent 102 and/or one or more viewers 112 may use the GUI presented on the display of the data analytics setup computer 104 or the display 110 to provide such inputs. Such inputs from the agent 102 and/or one or more viewers 112 may include indicating a starting point, an ending point, a scale, a range, etc., of the one or more rows of data stored in the database server device 108 that are to be displayed on the display 110 as one or more visualizations.

In an operation 314, based upon the user inputs received in the operation 312, the processor 210 modifies the one or more visualizations on the display 110 to generate animation of the data displayed. Such generation of the animation may be in response to the agent 102 altering, using the processor 210, at least one data dimension (i.e., data along a row of an array) of the data stored in the database server device 108. The alteration of the data may include updating values of metrics, or selecting metrics other than those already displayed as one or more visualizations on the display 110. In one aspect, such updating may be carried out during the respective animations generated on the one or more visualizations. An advantage of such real-time or dynamic updating is that the agent 102 can convey information regarding data analytics to the one or more viewers 112 while the agent 102 has the attention of the one or more viewers 112 making the data analytics contextual and relevant to the presentation for which the data analytics animation system 100 is being used. Alternatively, in one aspect, such updating of the data to be presented in one or more visualizations on the display 110 may be carried out after a particular animation of the one or more visualizations has stopped. In one aspect, the agent 102 may provide inputs to the processor 210 for a pause operation, a play operation, a fast-forward operation, a fast-reverse operation, a stop operation, a forward-skip operation, a backward-skip operation, a zoom-in operation, or a zoom-out operation during the respective animations using the GUI or other interface available, for example, on the data analytics setup computer 104.

In one aspect, the animations for a visualization displayed on the display 110 may be carried out as discussed using the examples of filters in Tables I-VI and the corresponding visualization 402 shown evolving progressively from FIG. 4-9 based upon changes to the filters indicated by Tables I-VI. In the operation 314, to start the animation, the agent 102 sets a filter shown as Table I with only one row of data at starting point. The starting point is initially is the same as a current pointer. The middle column of Table I illustrates an exemplary date range (shown as element 404 in FIGS. 4-9) for which the animation will be carried out. In this example, the start date is set to Mar. 5, 2010 and the end date is set to Mar. 10, 2010, although other ranges may be selected. Various data associated with this exemplary date range are stored in the database server device 108, and are provided to the processor 210. Three such data metrics 408, 410, and 412 are illustrated in the visualization 402 as “Sum of Cashiers” (408), “Sum of Registers” (410), and “Sum of Transactions” (412). Corresponding values of these data metrics 408, 410, and 412 are illustrated along axes 408(1), 410(1), and 412(1). A graph 414 illustrates a current state of the data metrics 408, 410, and 412 for the filter selected for a single day (or, 24 hours) as indicated by the “Current Pointer” of Table 1. In one aspect, the processor 210 may perform analytics on filter measures/metrics for cashiers, registers, transactions over a dimension of 24 hours of time during or prior to displaying the visualization 402. It is to be noted that likewise additional visualizations may be presented in parallel with the visualization 402 on the display 110 where additional data metrics, e.g., type of product, quantity, customer age, income level, etc., may be displayed for the date/time range indicated in Table I.

TABLE I

| | | |
|---|---|---|
| Starting | 3/5/2010 | Current |
| Point | | Pointer |
| | 3/6/2010 | |
| | 3/7/2010 | |
| | 3/8/2010 | |
| | 3/9/2010 | |
| End | 3/10/2010 | |
| Point | | |

Further in the operation 314, the next row of date is added to the filter accumulation of data keeping the initial starting point but moving the current row to the next row for day Mar. 5, 2010 and day Mar. 6, 2010 as indicated in Table II.

TABLE II

| | | |
|---|---|---|
| Starting | 3/5/2010 | |
| Point | | |
| | 3/6/2010 | Current |
| | | Pointer |
| | 3/7/2010 | |
| | 3/8/2010 | |
| | 3/9/2010 | |
| Ending | 3/10/2010 | |
| Point | | |

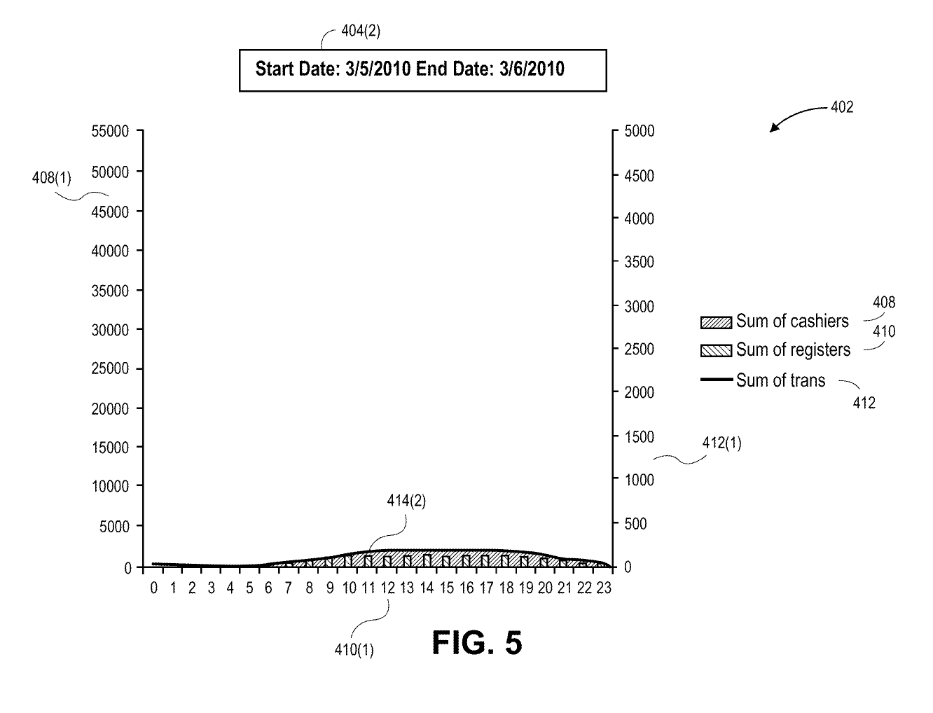

As a result of such updating of the filter by the agent 102 and/or the one or more viewers 112, the graph 414(1) changes to a graph 414(2), as illustrated in FIG. 5. Since the change from the graph 414(1) to the graph 414(2) occurs at a fast rate greater than the rate of human eye perception, the one or more viewers 112 see the change from the graph 414(1) to the graph 414(2) as an animation on the display 110.

Continuing with the operation 314, the next row to the filter accumulation of data is added, as shown in Table III keeping the initial starting point but moving the current row to the next row for day Mar. 5, 2010, Mar. 6, 2010, and day Mar. 7, 2010.

TABLE III

| | | |
|---|---|---|
| Starting | 3/5/2010 | |
| Pointer | | |
| | 3/6/2010 | |
| | 3/7/2010 | Current |
| | | Pointer |
| | 3/8/2010 | |
| | 3/9/2010 | |
| Ending | 3/10/2010 | |
| Point | | |

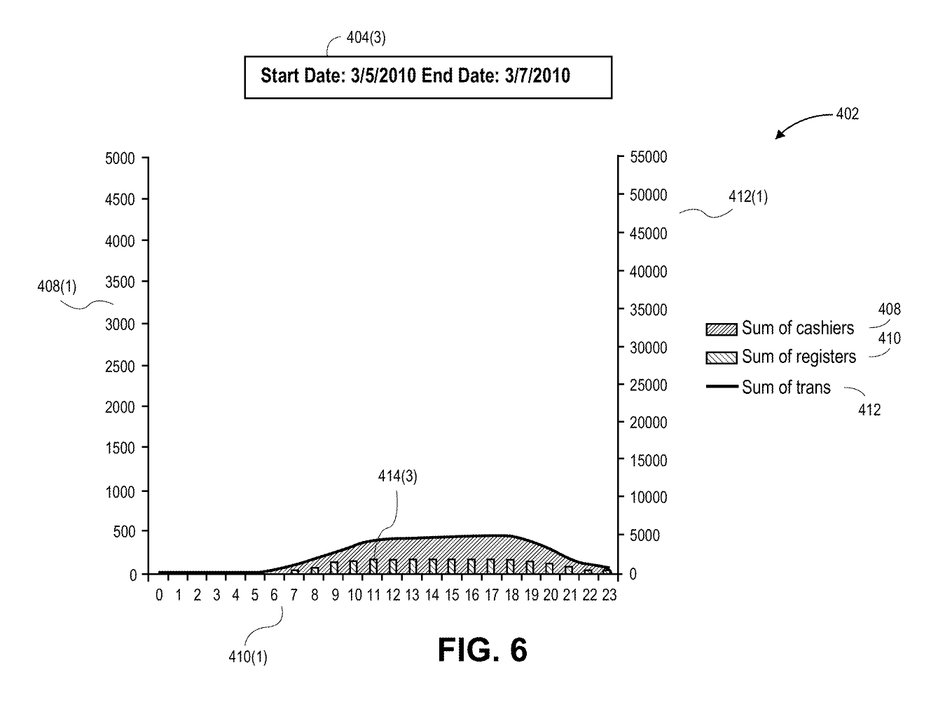

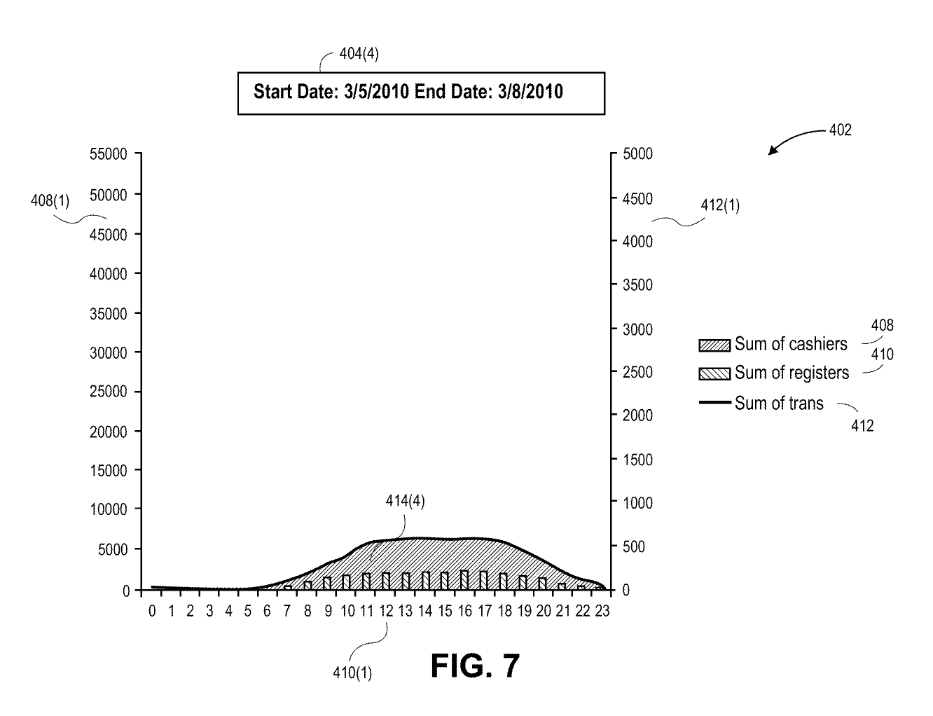

Correspondingly, the graph 414(2) of the visualization changes to a graph 414(3), as shown in FIG. 6. Likewise, in Tables IV, V, and VI (where start and end pointers meet), presented below, the filter is incrementally row by row advanced for each date, and correspondingly visualization 402 adds the graphs 414(4), 414(5), and 414(6), respectively, to provide the animation as each successive graph is displayed on the display 110, as illustrated in corresponding FIGS. 7-9, respectively.

TABLE IV

| | | |
|---|---|---|
| Starting | 3/5/2010 | |
| Point | | |
| | 3/6/2010 | |
| | 3/7/2010 | |
| | 3/8/2010 | Current |
| | | Pointer |
| | 3/9/2010 | |
| Ending | 3/10/2010 | |
| Point | | |

TABLE V

| | | |
|---|---|---|
| Starting | 3/5/2010 | |
| Point | | |
| | 3/6/2010 | |
| | 3/7/2010 | |
| | 3/8/2010 | |
| | 3/9/2010 | Current |
| | | Pointer |
| Ending | 3/10/2010 | |
| Point | | |

TABLE VI

| | | |
|---|---|---|
| Starting | 3/5/2010 | |
| Point | | |
| | 3/6/2010 | |
| | 3/7/2010 | |
| | 3/8/2010 | |
| | 3/9/2010 | |
| Ending | 3/10/2010 | Current |
| Point | | Pointer |

In one aspect of the disclosure, the animation performed in the operation 314 may be carried out using one or more of accumulation, switching, and zooming techniques, or using combinations thereof. For example, the accumulation technique is illustrated using the filter in Tables I-VI. In this technique, each row is piled upon the previous row to generate the animation of the graphs 414(1)-414(6) of the visualization 402. In the switching technique, the filter may select time periods or other data ranges that are disjoint, and display the data for such disjoint data sets on the visualization 402. For example, in the switching technique, a table similar to Tables I-VI may have twelve months of the year. The current pointer may then be moved to only show data for each month separately as the visualization 402 evolves from the graphs 414(1)-414(6) to present the animation. Finally, in the zooming technique, additional or lesser data points may be accessed from the database server device 108 based on whether a zoom-in or a zoom-out operation was carried out by the agent 102. Accordingly, the visualization 402 may show the graphs 414(1)-414(6) in more detail or in less detail, based on whether a zoom-in or a zoom-out operation was carried out by the agent 102. That is, a scale or granularity of the data visualization on the display 110 may be changed using the zooming operation. The zoom in or zoom out may cause more or less rows of information due to the different level of granularity and the hierarchy level. For example, there are only 50 states in the USA but a particular state may have more than 50 counties or less than 50 counties. A county may have more or less than 50 cities. The real time update to this information would adjust the filtering window to move from the past to more of the current shifting the time range but not increasing the time, unless it is an accumulation for real time. In that case, there would be a starting point like the current time, and then as time increased the range size would increase accumulating incrementally the additional time giving the animation effect of growth.

By way of example only, various aspects of this disclosure provide speedy updation and visualization by querying the whole dataset, aggregating or mashing all results of the query, and then only shift the filter on the pre-queried, pre-aggregated data. By doing this, the pre-aggregated data is linked with other pre-aggregated data and quickly shows animated changes by shifting or accumulating the rows in the filter. For real time information, only the additional new information has to be queried and appended to the previous query results. Other exemplary advantages of the various aspects of this disclosure include the ability to use multiple graph types within the same chart (bar, line, area, etc.), the ability to use multiple charts at the same time and link them together, the ability to accommodate any dimension and multiple dimensions of data, and the ability to link charts without impacting speed or computational performance of the processor 210 or other processors used in the data analytics animation system 100.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A method for animating data analytics on a display, comprising:
receiving, at a processor, a first request to display a set of data, the set of data including a plurality of data dimensions having respective data;
generating, using the processor, one or more visualizations of the set of data corresponding to at least two data dimensions;
applying, at the processor, a filter to select one or more data ranges to be displayed along the at least two data dimensions;
displaying, at the display, each of the one or more visualizations at respective sets of pixels of the display based upon the applied filter;
generating, using the processor, respective animations of the displayed one or more visualizations by simultaneously displaying respective variations in the at least two data dimensions on the respective sets of the pixels of the display; and
altering, using the processor, as the filter is applied, at least one data dimension such that the one or more visualizations are concurrently updated during the respective animations to reflect the altered at least one data dimension.

2. The method of claim 1 further comprising:
receiving, at the processor, a second request to perform at least one of a pause operation, a play operation, a fast-forward operation, a fast-reverse operation, a stop operation, a forward-skip operation, a backward-skip operation, a zoom-in operation, and a zoom-out operation during the respective animations; and
further altering, using the processor, the respective animations on the display based upon the received second request.

3. The method of claim 1, wherein one of the at least two data dimensions is common to at least two visualizations.

4. The method of claim 1, wherein the one or more visualizations are at least one of a graph, a bar-chart, a pie-chart, a geospatial visualization, and a line chart, or combinations thereof.

5. The method of claim 1, wherein the at least two data dimensions comprise the respective data arranged in arrays having respective starting points and ending points, and wherein the animations display successive data points between the respective starting points and the ending points to illustrate the respective variations in the at least two data dimensions on the respective at least two sets of the pixels of the display to a viewer viewing the display.

6. The method of claim 1, wherein the generating the at least two visualizations comprises:
querying, using the analytic engine, a database to retrieve the at least two data dimensions;
combining, using the analytic engine, the retrieved at least two data dimensions to bring the data associated therewith to a common format; and
providing, to the processor, the combined data of the at least two data dimensions for performing the respective animations of the at least two visualizations.

7. The method of claim 1 further comprising:
arranging the set of data in a plurality of rows in an array format such that the generating the respective animations comprises iteratively accumulating individual rows in each iteration.

8. A data analytics animation system, comprising:
a computing device including:
a database including a memory having instructions stored thereupon to animate data analytics associated with a set of data stored in the database,
a processor coupled to the database,
an input-output interface coupled to the processor, and
a display unit coupled to the processor,
wherein the instructions when executed by the processor, cause the processor to:
receive a first request, at the input-output interface, to display the set of data including a plurality of data dimensions, said plurality of data dimensions including respective data,
generate at least two visualizations of the set of data corresponding to at least two data dimensions,
apply a filter to select one or more data ranges to be displayed along the at least two data dimensions;
display, at the display, each of the at least two visualizations at respective at least two sets of pixels of the display,
generate respective animations of the displayed at least two visualizations by simultaneously displaying respective variations in the at least two data dimensions on the respective at least two sets of the pixels of the display to a viewer viewing the display, and
alter, as the filter is applied, at least one data dimension such that the at least two visualizations are updated during the respective animations to reflect the altered at least one data dimension.

9. The data analytics animation system of claim 8, wherein the instructions when executed by the processor, further cause the processor to:
receive at the input-output interface a second request to perform at least one of a pause operation, a play operation, a fast-forward operation, a fast-reverse operation, a stop operation, a forward-skip operation, a backward-skip operation, a zoom-in operation, and a zoom-out operation during the respective animations; and
further alter the respective animations on the display based upon the received second request.

10. The data analytics system of claim 8, wherein one of the at least two data dimensions is common to the at least two visualizations.

11. The data analytics system of claim 8, wherein the at least two visualizations are at least one of a graph, a bar-chart, a pie-chart, a geospatial visualization, and a line chart, or combinations thereof.

12. The data analytics system of claim 8, wherein the at least two data dimensions comprise the respective data arranged in arrays having respective starting points and ending points, and wherein the animations display successive data points between the respective starting points and the ending points to illustrate the respective variations in the at least two data dimensions on the respective at least two sets of the pixels of the display to the viewer viewing the display.

13. The data analytics system of claim 8, wherein the instructions when executed by the processor, further cause the processor to generate the at least two visualizations by:
activating an analytic engine to carry out data analytics on the set of data;
querying a database to retrieve the at least two data dimensions;
combining the retrieved at least two data dimensions to bring the data associated therewith to a common format; and
providing the combined data of the at least two data dimensions to perform the respective animations of the at least two visualizations.

14. The data analytics system of claim 8, wherein the set of data is arranged in a plurality of rows in an array format such that the processor generates the respective animations by iteratively accumulating individual rows in each iteration.

15. A computer readable medium storing computer executable instructions thereupon for animating data analytics on a display, the instructions when executed by a processor cause the processor to:
receive a first request, at the input-output interface, to display the set of data, the set of data including a plurality of data dimensions having respective data,
generate at least two visualizations of the set of data corresponding to at least two data dimensions,
apply a filter to select one or more data ranges to be displayed along the at least two data dimensions,
display, at the display, each of the at least two visualizations at respective at least two sets of pixels of the display,
generate respective animations of the displayed at least two visualizations by simultaneously displaying respective variations in the at least two data dimensions on the respective at least two sets of the pixels of the display to a viewer viewing the display, and
alter, as the filter is applied, at least one data dimension such that the at least two visualizations are updated during the respective animations to reflect the altered at least one data dimension.

16. The computer readable medium of claim 15, wherein the instructions, when executed by the processor, further cause the processor to:
receive at the input-output interface a second request to perform at least one of a pause operation, a play operation, a fast-forward operation, a fast-reverse operation, a stop operation, a forward-skip operation, a backward-skip operation, a zoom-in operation, and a zoom-out operation during the respective animations; and
further alter the respective animations on the display based upon the received second request.

17. The computer readable medium of claim 15, wherein one of the at least two data dimensions is common to the at least two visualizations.

18. The computer readable medium of claim 15, wherein the at least two visualizations are at least one of a graph, a bar-chart, a pie-chart, a geospatial visualization, and a line chart, or combinations thereof.

19. The computer readable medium of claim 15, wherein the at least two data dimensions comprise respective data arranged in arrays having respective starting points and ending points, and wherein the animations display successive data points between the respective starting points and the ending points to illustrate the respective variations in the at least two data dimensions on the respective at least two sets of the pixels of the display to the viewer viewing the display.

20. The computer readable medium of claim 15, wherein the set of data is arranged in a plurality of rows in an array format such that the processor generates the respective animations by iteratively accumulating individual rows in each iteration to generate the respective animations of the at least two visualizations on the display.
